(19) United States
(12) Patent Application Publication
(10) Pub. No.: US 2025/0372927 A1
(43) Pub. Date: Dec. 4, 2025

(54) COAXIAL CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Takashi NATSUME, Mie (JP); Shinji TANAKA, Mie (JP); Yasunori ASANO, Mie (JP); Hiroyuki ISHIGURE, Mie (JP); Yutaka KOBAYASHI, Mie (JP)

(21) Appl. No.: 18/873,327

(22) PCT Filed: May 25, 2023
(86) PCT No.: PCT/JP2023/019518

§ 371 Date: Dec. 10, 2024

(30) Foreign Application Priority Data
Jun. 13, 2022 (JP) 2022-094991

(51) Int. Cl. H01R 24/50; H01R 103/00

(52) U.S. Cl. CPC H01R 24/50; H01R 2103/00

(57) ABSTRACT

The purpose of the present invention is to preferably connect a counterpart-side inner conductor to an inner conductor housed in an insulator. This coaxial connector is to be connected to a counterpart-side coaxial connector having a counterpart-side inner conductor, and comprises: an inner conductor to which the counterpart-side inner conductor is connected; an insulator including a cylindrical part in which the inner conductor is to be housed; and an outer conductor that surrounds the insulator. In the inner circumferential section of the cylindrical part, a rib is formed so as to partially project in the circumferential direction of the inner circumferential section of the cylindrical part and to extend in the axial direction of the cylindrical part.

### TECHNICAL FIELD

The present disclosure relates to a coaxial connector.

### BACKGROUND

Patent Document 1 discloses a board-side connector including a board-side inner conductor, a board-side dielectric and a board-side outer conductor. The board-side inner conductor is accommodated in the board-side dielectric. A tab of a movable-side inner conductor is connected to the board-side inner conductor in the board-side inner conductor.

### PRIOR ART DOCUMENT

### Patent Document

Patent Document 1: JP 2022-030014 A

### SUMMARY OF THE INVENTION

### Problems to be Solved

In Patent Document 1, it is desired to enable better connection of another inner conductor to the inner conductor.

Accordingly, the present disclosure aims to enable a mating inner conductor to be satisfactorily connected to an inner conductor accommodated in an insulator.

### Means to Solve the Problem

The present disclosure is directed to a coaxial connector to be connected to a mating coaxial connector including a mating inner conductor, the coaxial connector being provided with an inner conductor to be connected to the mating inner conductor, an insulator including a tube portion for accommodating the inner conductor, and an outer conductor surrounding the insulator, an inner peripheral part of the tube portion being formed with a rib partially projecting in a circumferential direction of the inner peripheral part of the tube portion and extending along an axial direction of the tube portion.

### Effect of the Invention

According to the present disclosure, it is aimed to enable a mating inner conductor to be satisfactorily connected to an inner conductor accommodated in an insulator.

### BRIEF DESCRIPTION OF THE DRAWINGS

FIG. 1 is a perspective view showing a device provided with a coaxial connector according to an embodiment.

FIG. 2 is a section along II-II of FIG. 1.

FIG. 3 is a perspective view showing the coaxial connector.

FIG. 4 is a bottom view showing the coaxial connector.

FIG. 5 is an exploded perspective view showing the coaxial connector.

FIG. 6 is a perspective view showing an insulator.

FIG. 7 is a section along VII-VII of FIG. 4.

FIG. 8 is a section along VIII-VIII of FIG. 4.

FIG. 9 is a section along IX-IX of FIG. 3.

### DETAILED DESCRIPTION TO EXECUTE THE INVENTION

### Description of Embodiments of Present Disclosure

First, embodiments of the present disclosure are listed and described.

The coaxial connector of the present disclosure is as follows.

(1) The coaxial connector of the present disclosure is to be connected to a mating coaxial connector including a mating inner conductor and provided with an inner conductor to be connected to the mating inner conductor, an insulator including a tube portion for accommodating the inner conductor, and an outer conductor surrounding the insulator, an inner peripheral part of the tube portion being formed with a rib partially projecting in a circumferential direction of the inner peripheral part of the tube portion and extending along an axial direction of the tube portion.

According to the present disclosure, the inner peripheral part of the tube portion is formed with the rib partially projecting in the circumferential direction of the inner peripheral part of the tube portion and extending along the axial direction of the tube portion. Thus, a gap between the inner conductor and the insulator can be reduced in a part formed with the rib. In this way, the mating inner conductor is hardly erroneously inserted between the inner conductor and the insulator and the mating inner conductor can be satisfactorily connected to the inner conductor accommodated in the insulator.

(2) In the coaxial connector of (1), the inner conductor may include a plurality of resilient pieces located at intervals in the circumferential direction, and the rib may be located between the plurality of resilient pieces in the circumferential direction.

In this case, since the rib is located between the plurality of resilient pieces in the circumferential direction of the inner peripheral part of the tube portion, the rib hardly hinders the resilient deformation of the plurality of resilient pieces. In this way, the mating inner conductor can be smoothly inserted between the plurality of resilient pieces. Further, the rib can suppress the erroneous entrance of the mating inner conductor between the inner conductor and the insulator between the plurality of resilient pieces and the inner peripheral part of the tube portion.

(3) In the coaxial connector of (2), the plurality of resilient pieces may be located at equal intervals about a center axis of the tube portion, a plurality of the ribs may be provided, and the plurality of ribs may be located at equal intervals about the center axis of the tube portion.

In this case, the plurality of resilient pieces can uniformly sandwich the mating inner conductor from around. The plurality of ribs can uniformly suppress the erroneous insertion of the mating inner conductor between the plurality of resilient pieces.

(4) In the coaxial connector of (2) or (3), the inner conductor may include a base end tube portion located on a base end side of the tube portion, the plurality of resilient pieces extend from the base end tube portion toward a tip side of the tube portion, and the rib may be located in a region closer to the tip side of the tube portion than the base end tube portion.

In this way, the base end tube portion needs not be shaped to avoid the rib, wherefore the base end tube portion is easily processed.

(5) In the coaxial connector of (4), a base end part of the rib may have a slope gradually extending toward the center axis of the tube portion from the base end side toward the tip side of the tube portion.

In this way, the resilient piece is hardly hooked to the base end part of the rib and the inner conductor is smoothly inserted into the tube portion.

(6) In the coaxial connector of (4) or (5), the base end tube portion may include a positioning protrusion partially projecting toward an outer peripheral side in a circumferential direction of the base end tube portion, and the tube portion may include a positioning recess, the positioning protrusion being fit into the positioning recess.

In this case, the rib can be precisely located between the plurality of resilient pieces in the circumferential direction of the inner peripheral part of the tube portion by fitting the positioning protrusion into the positioning recess.

(7) In the coaxial connector of any one of (4) to (6), the inner peripheral part of the tube portion may be formed with a positioning rib partially projecting in the circumferential direction, extending along the center axis of the tube portion and in contact with an outer peripheral part of the base end tube portion.

The positioning rib contacts the outer peripheral part of the base end tube portion in this way, whereby the base end tube portion is easily supported at a fixed position in the tube portion.

(8) In the coaxial connector of (7), a plurality of the positioning ribs may be provided, and the plurality of positioning ribs may be located at equal intervals about the center axis of the tube portion. By the contact of the plurality of positioning ribs with the base end tube portion at equal intervals about the center axis of the tube portion in this way, the center axis of the tube portion and that of the base end tube portion are easily aligned.

(9) In the coaxial connector of any one of (1) to (8), the insulator may include a tip guide portion located on a tip side of the tube portion and having an insertion hole with a diameter smaller than an inner diameter of the tube portion, and the insertion hole may have a guide surface gradually reduced in diameter toward inside of the tube portion.

In this case, the mating inner conductor is guided toward the inner conductor by the guide surface. In this way, the mating inner conductor is hardly erroneously inserted between the inner conductor and the insulator and the mating inner conductor can be more satisfactorily connected to the inner conductor accommodated in the insulator.

(10) In the coaxial connector of (9), the insertion hole may have a constant-diameter guide surface extending toward the tube portion from a peripheral edge of the guide surface on the tube portion side.

In this case, the constant-diameter guide surface can more reliably guide the mating inner conductor toward the inner conductor.

(11) In the coaxial connector of any one of (1) to (10), the outer conductor may include an outer conductor conductive piece conductive with a mating outer conductor in a posture oblique to the mating outer conductor of the mating coaxial connector.

If the outer conductor terminal includes the outer conductor terminal conductive piece conductive with the mating outer conductor in the posture oblique to the mating outer conductor of the mating coaxial connector in this way, position errors of the coaxial connector and the mating coaxial connector can be absorbed. In this case, the inner conductor and the mating outer conductor are thought to be in oblique postures. Even in this case, the mating inner conductor is hardly erroneously inserted between the inner conductor and the insulator, and the mating inner conductor can be more satisfactorily connected to the inner conductor to be accommodated in the insulator.

### Details of Embodiment of Present Disclosure

A specific example of a coaxial connector of the present disclosure is described with reference to the drawings. Note that the present disclosure is not limited to these illustrations, but is represented by claims and intended to include all changes in the scope of claims and in the meaning and scope of equivalents.

### Embodiment

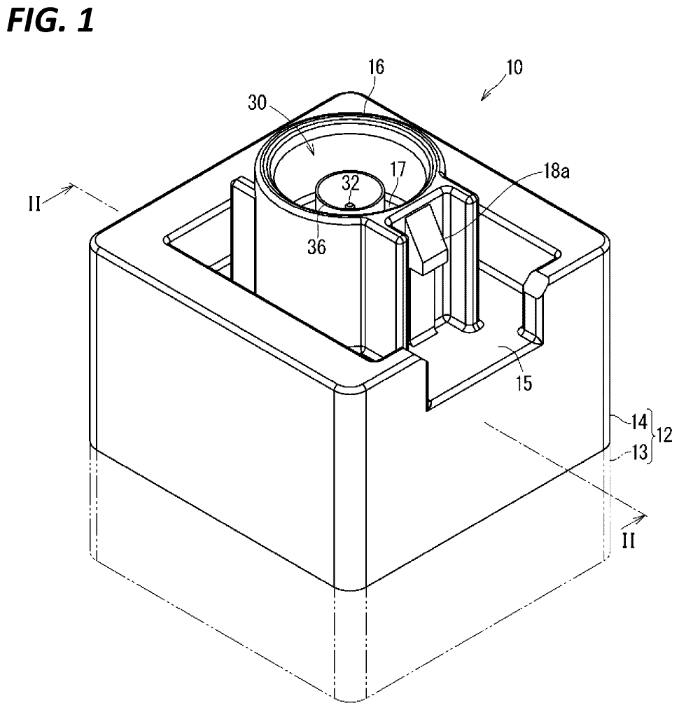

Hereinafter, a coaxial connector according to an embodiment is described. FIG. 1 is a perspective view showing a device 10 provided with a coaxial connector 60.

### <Concerning Overall Configuration of Device>

The device 10 is, for example, a camera device. The camera device is, for example, an in-vehicle device. The device 10 may not be a camera device.

The device 10 is provided with a case 12 and an electrical component 20. The electrical component 20 is accommodated in the case 12. The coaxial connector 60 is fixed to the electrical component 20.

The case 12 is provided with a first case 13 and a second case 14. The first and second cases 13, 14 are, for example, made of resin. By uniting the first and second cases 13, 14, the case 12 in the form of a rectangular parallelepiped box for accommodating the electrical component 20 is configured. If the device 10 is a camera device, it is assumed that the first case 13 includes a lens or window for imaging, and the second case 14 includes an external connection coaxial connector 30.

The external connection coaxial connector 30 is a coaxial connector for connecting the electrical component 20 and an external electrical component. For example, the external connection coaxial connector 30 is a coaxial connector, to which a cable connected to the external electrical component is connected. The cable connected to the external connection coaxial connector 30 is, for example, a coaxial cable.

More specifically, a holding tube portion 16 projects on a bottom portion 15 of the case 12. The holding tube portion 16 is a hollow cylinder and projects outward from a central part of the bottom portion 15. An inner opening of the holding tube portion 16 is open to the inside of the second case 14, and an outer opening of the holding tube portion 16 is open to the outside of the second case 14. A holding/partitioning portion 17 is formed in an intermediate part in a center axis direction of the holding tube portion 16. In this embodiment, the holding/partitioning portion 17 is formed at a position near the inner opening in the intermediate part in the direction of a center axis X of the holding tube portion 16. The holding/partitioning portion 17 partitions between a space on the side of the inner opening and a space on the side of the outer opening in the holding tube portion 16. The holding/partitioning portion 17 is formed with a holding hole 17h, and the external connection coaxial connector 30 is inserted and held in the holding hole 17h.

In this embodiment, a locking protrusion 18a for holding a cable connector mounted on an end part of a cable is formed on an outer peripheral part of the holding tube portion 16. It is not essential that the locking protrusion 18a is formed.

The external connection coaxial connector 30 is provided with an external connection inner conductor 32, an external connection insulator 34 and an external connection outer conductor 36.

The external connection inner conductor 32 is in the form of an elongated bar and made of an electrically conductive material such as metal. The external connection insulator 34 is made of an insulating material such as resin and surrounds the external connection inner conductor 32. In this embodiment, the external connection insulator 34 is a dielectric. The external connection outer conductor 36 is made of an electrically conductive material such as metal. The external connection outer conductor 36 is formed into a tubular shape surrounding the external connection insulator 34.

The electrical component 20 is, for example, a mounting board, in which electronic components are mounted on a board. If the device 10 is a camera device, the electrical component 20 is assumed to include a circuit board 21 and an imaging element 22 mounted on the circuit board 21. The imaging element 22 faces the lens or window for imaging of the first case 13 and images an outside view by turning the lens or window. The side of the first case 13, toward which the imaging element 22 is facing, may be referred to as a front side, and the side of the second case 14 opposite to the front side may be referred to as a rear side below.

In this embodiment, the coaxial connector 60 is located on a surface of the circuit board 21 opposite to the imaging element 22. The coaxial connector 60 is fixed to the circuit board 21 and projects from the circuit board 21 toward the external connection coaxial connector 30. The coaxial connector 60 is a board-side coaxial connector. The coaxial connector 60 is, for example, provided with an inner conductor 62, an insulator 70 and an outer conductor 90. A movable-side inner conductor 42 to be described later is connected to the inner conductor 62. The insulator 70 includes a tube portion 72, into which the inner conductor 62 is accommodated. The outer conductor 90 surrounds the insulator 70. That is, the inner conductor 62, the insulator 70 and the outer conductor 90 are concentrically arranged from a center toward an outer peripheral side in this order.

The coaxial connector 60 and the external connection coaxial connector 30 are connected via a relay connector 40. The relay connector 40 is, for example, provided with the movable-side inner conductor 42, a movable-side insulator 44 and a movable-side outer conductor 46. The movable-side insulator 44 surrounds the movable-side inner conductor 42. A dielectric can be grasped as one type of insulator, and the movable-side insulator 44 may be a dielectric. The movable-side outer conductor 46 surrounds the movable-side insulator 44. The movable-side inner conductor 42 is an example of a mating inner conductor to be connected to the inner conductor 62, the movable-side outer conductor 46 is an example of a mating outer conductor to be connected to the outer conductor 90, and the relay connector 40 is an example of a mating coaxial connector to be connected to the coaxial connector 60.

With the movable-side inner conductor 42 inserted and connected to the inner conductor 62 and the outer conductor 90 inserted and connected to the movable-side outer conductor 46, the relay connector 40 is connected to the coaxial connector 60. In this state, the relay connector 40 projects further toward the external connection coaxial connector 30 from the coaxial connector 60. By inserting and connecting the external connection inner conductor 32 to the movable-side inner conductor 42 and inserting and connecting the movable-side outer conductor 46 to the external connection outer conductor 36, the relay connector 40 is connected to the external connection coaxial connector 30. In this way, the relay connector 40 relays and connects the coaxial connector 60 and the external connection coaxial connector 30.

In this way, by connecting the external cable to the external connection coaxial connector 30, the external electrical component as a connection destination of this cable and the electrical component 20 in the case 12 are electrically connected.

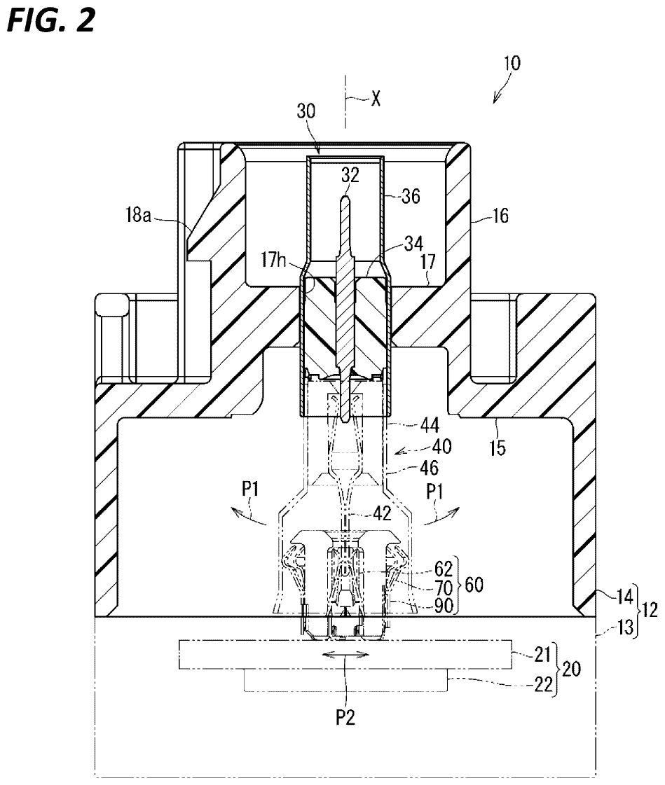

In a connected state of the relay connector 40 and the coaxial connector 60, the movable-side inner conductor 42 is inserted and connected in an inclined state to the inner conductor 62. Further, the outer conductor 90 is inserted and connected in an inclined state to the movable-side outer conductor 46. That is, the relay connector 40 can be connected in an inclined state to the coaxial connector 60 (see an arrow P1 of FIG. 2). In this way, even if the coaxial connector 60 and the external connection coaxial connector 30 deviate from positions facing each other on the same axis (see an arrow P2 of FIG. 2) during an assembly operation or in a completed state of the device 10, the relay connector 40 is inclined with respect to the coaxial connector 60, thereby absorbing these positional deviations.

### <Concerning Coaxial Connector>

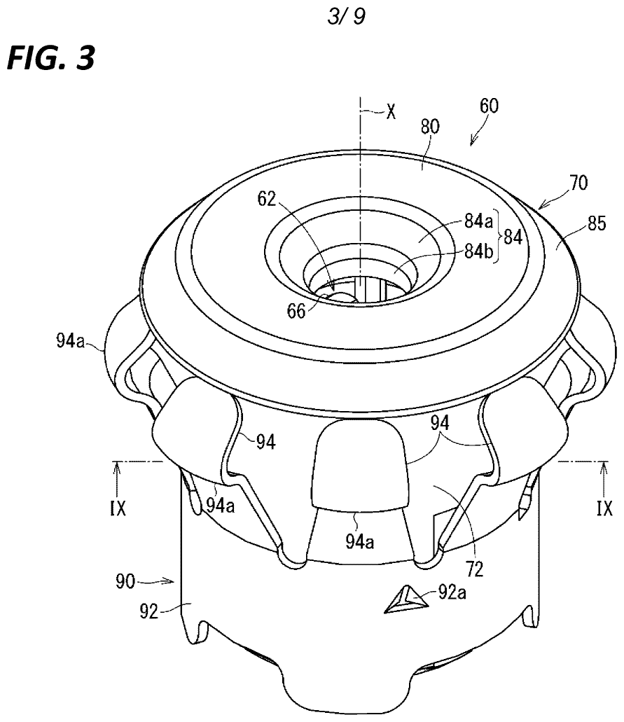

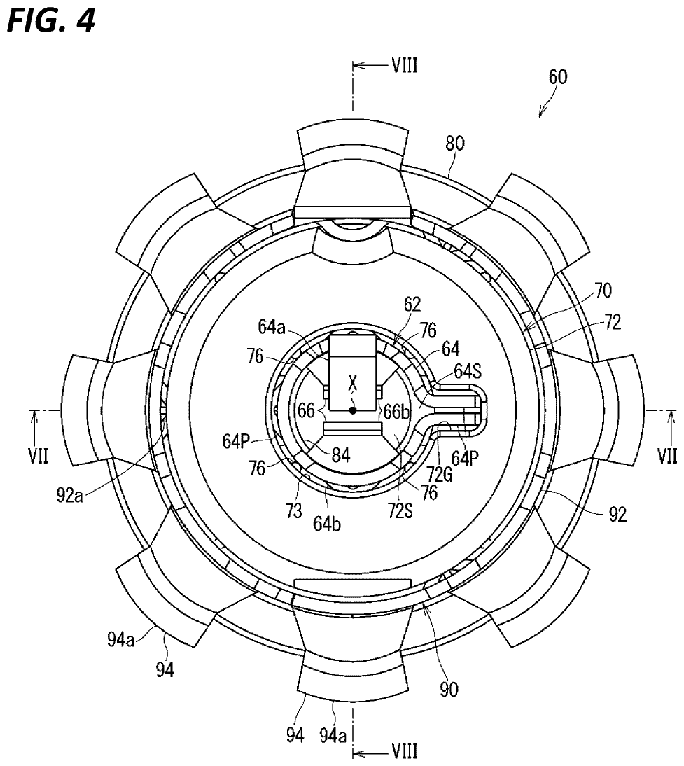

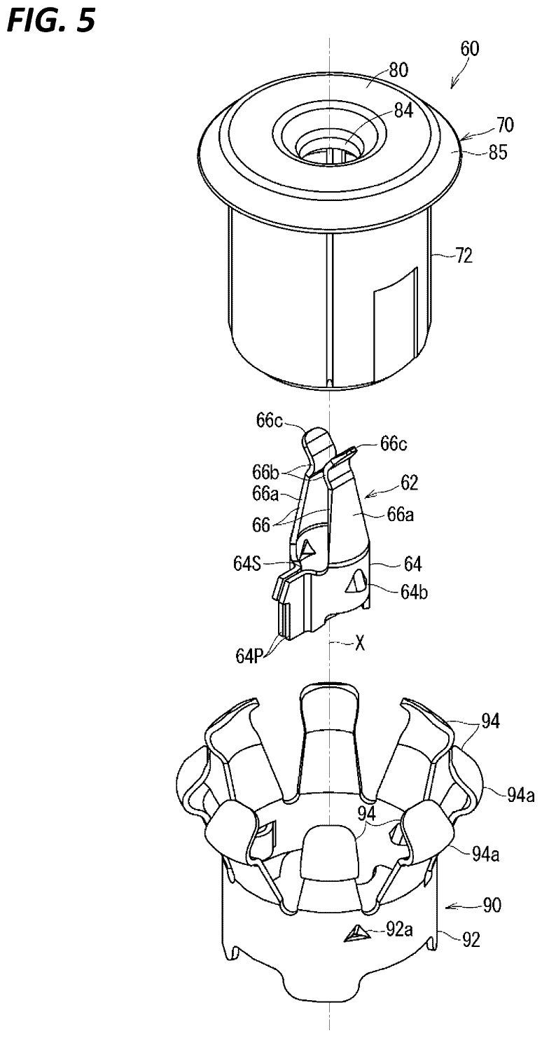

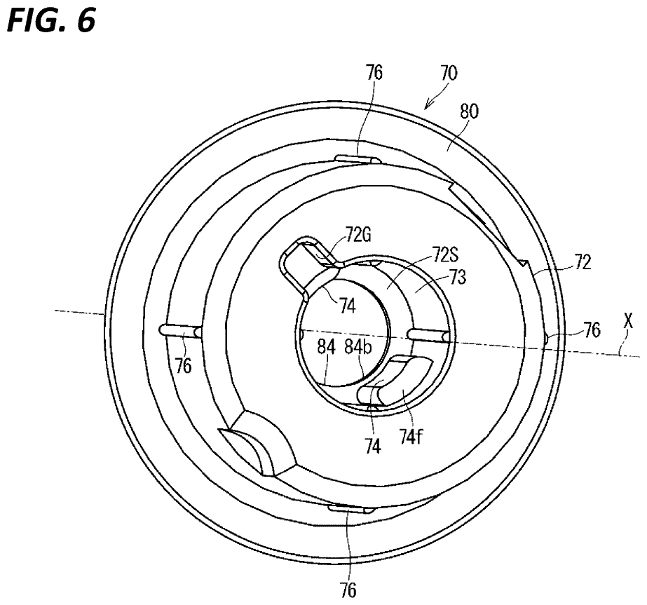

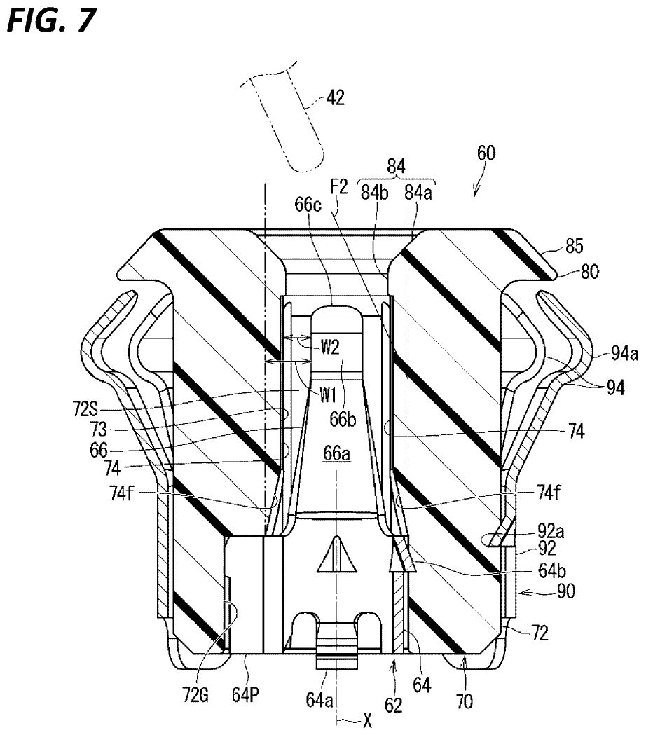

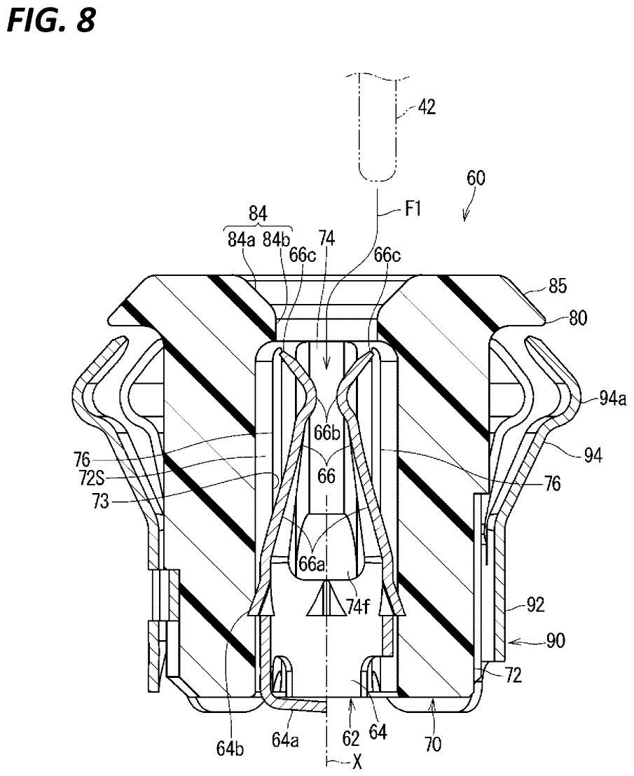

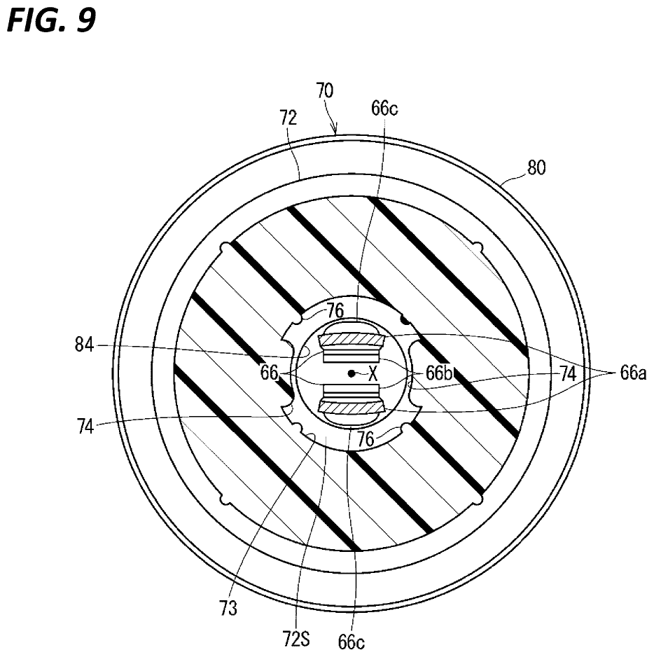

The coaxial connector 60 is specifically described. FIG. 3 is a perspective view showing the coaxial connector 60. FIG. 4 is a bottom view showing the coaxial connector 60. FIG. 5 is an exploded perspective view showing the coaxial connector 60. FIG. 6 is a perspective view showing the insulator 70. FIG. 7 is a section along VII-VII of FIG. 4. FIG. 8 is a section along VIII-VIII of FIG. 4. FIG. 9 is a section along IX-IX of FIG. 3. The outer conductor 90 is not shown in FIG. 9.

As described above, the coaxial connector 60 is, for example, provided with the inner conductor 62, the insulator 70 and the outer conductor 90.

The inner conductor 62 is an elongated electrically conductive member (see FIGS. 5 and 7 to 9). In this embodiment, the inner conductor 62 is formed by press-working a metal plate. More specifically, the inner conductor 62 includes a base end tube portion 64 and a plurality of resilient pieces 66.

The base end tube portion 64 is formed into a tubular shape, more specifically a hollow cylindrical shape. The base end tube portion 64 is accommodated on a base end side of the tube portion 72. Note that, in the coaxial connector 60, a tip is an end on a side to be connected to the movable-side inner conductor 42, and the base end is an end opposite to the tip, here, an end on a side facing the circuit board 21.

The base end tube portion 64 includes positioning protrusions 64P partially projecting toward an outer peripheral side in a circumferential direction. In this embodiment, a slit 64S is formed in a circumferential part of the base end tube portion 64. A pair of the positioning protrusions 64P project outwardly of the base end tube portion 64 from a pair of edge parts on both sides of the slit 64S in the base end tube portion 64. The pair of positioning protrusions 64P are parallel to each other. It is not essential that the positioning protrusions 64 are configured as described above. A positioning protrusion may be formed by deforming a circumferential part of an annular base end tube portion to partially project toward an outer peripheral side. The positioning protrusion(s) may be omitted.

An extended piece 64a extends inwardly of the base end tube portion 64 from a base end side edge of the base end tube portion 64. The extended piece 64a may be soldered to a circuit of the circuit board 21.

Locking protrusions 64B project on the base end tube portion 64. The locking protrusion 64b partially projects from an outer peripheral part of the base end tube portion 64. The locking protrusion 64b is formed into a shape having a projecting dimension gradually increased from the tip toward the base end of the base end tube portion 64. Further, the locking protrusion 64b has a surface facing the base end side of the base end tube portion 64. In this embodiment, the surface of the locking protrusion 64b facing the base end side of the base end tube portion 64 is a surface orthogonal to a center axis X of the base end tube portion 64. In this embodiment, the pair of positioning protrusions 64P and a plurality of (three) locking protrusions 64b are located at equal intervals (here, an interval of 90°) about the center axis X of the base end tube portion 64. Note that the center axis X of the base end tube portion 64 is aligned with a center axis X of the tube portion 72 of the insulator 70 and also aligned with a center axis X of the entire coaxial connector 60.

The plurality of resilient pieces 66 are located at intervals in the circumferential direction of the tube portion 72 in the tube portion 72. Preferably, the plurality of resilient pieces 66 are located at equal intervals about the center axis X of the tube portion 72. Here, equal intervals are equal within an error range (e.g. equal within a range of ±5° about the center axis X). In this embodiment, the plurality of resilient pieces 66 extend from one end edge of the base end tube portion 64 at intervals in the circumferential direction of the base end tube portion 64. The base end tube portion 64 is located on the base end side of the tube portion 72, and the plurality of resilient pieces 66 extend toward the tip side of the tube portion.

In this embodiment, the plurality of resilient pieces 66 are two resilient pieces 66. Thus, the two resilient pieces 66 extend from two facing positions of an annular edge on one end of the base end tube portion 64. That is, the two resilient pieces 66 are located at intervals of 180° in the circumferential direction of the tube portion 72 with respect to a center between the two resilient pieces 66 in a width direction. Two gaps are present between the two resilient pieces 66 in the circumferential direction of the base end tube portion 64. The resilient piece 66 includes an intermediate piece 66a extending from the base end tube portion 64, a contact point portion 66b and a guide piece 66c. The intermediate piece 66a is inclined toward the center axis X of the base end tube portion 64 with distance from the one end of the base end tube portion 64. Further, the intermediate piece 66a is formed to be gradually narrower toward a tip side. The contact point portion 66b extends in a direction away from the base end tube portion 64 from the tip of the intermediate piece 66a. The contact point portion 66b is formed into a curved shape convex toward the center axis X of the base end tube portion 64. The guide piece 66c is connected to the tip of the contact point portion 66b. The guide piece 66c is inclined away from the center axis X of the base end tube portion 64 with distance from the base end tube portion 64. The tip edge of the guide piece 66c is rounded.

Since the two resilient pieces 66 are facing each other, the two contact point portions 66b are facing each other. Further, the two guide pieces 66c extend toward sides opposite to each other. The movable-side inner conductor 42 to be inserted between the two resilient pieces 66 is guided toward a space between the two contact point portions 66b by at least one of the two guide pieces 66c and sandwiched by the two contact point portions 66b. In this state, out of the two contact point portions 66b, parts closest to the center axis X of the base end tube portion 64 contact the movable-side inner conductor 42. In this way, the movable-side inner conductor 42 is kept in a state electrically connected to the inner conductor 62. That is, the movable-side inner conductor 42 is properly connected to the inner conductor 62 while being sandwiched between the two contact point portions 66b.

Out of the resilient piece 66, the contact point portion 66b projects more toward the center axis X than other parts. Thus, even if the movable-side inner conductor 42 is inclined with respect to the inner conductor 62, the parts of the resilient piece 66 other than the contact point portion 66b hardly interfere with the movable-side inner conductor 42. Thus, even if the movable-side inner conductor 42 is inclined with respect to the inner conductor 62, a pair of the contact point portions 66b satisfactorily sandwich the movable-side inner conductor 42 and establish a properly connected state of the movable-side inner conductor 42 and the inner conductor 62.

Note that three or more resilient pieces may be provided. In this case, a state where the movable-side inner conductor is arranged in a part surrounded by three or more resilient pieces may be a properly connected state.

The insulator 70 is made of resin or the like. A dielectric can be grasped as one type of insulator, and the insulator 70 may be a dielectric. The insulator 70 is, for example, a molded resin component.

The insulator 70 is provided with the tube portion 72 and a tip guide portion 80.

The tube portion 72 is formed into a tubular shape capable of accommodating the inner conductor 62. In this embodiment, the tube portion 72 is formed into a hollow cylindrical shape and a cylindrical space 72S is formed inside. The cylindrical space 72S is formed to be able to accommodate the entire inner conductor 62. Here, a length of the cylindrical space 72S is larger than that of the inner conductor 62. An inner diameter of the cylindrical space 72S is equal to or larger than an outer diameter of the base end tube portion 64.

As described above, the base end tube portion 64 is accommodated on the base end side of the cylindrical space 72S. The tube portion 72 is formed with a positioning recess 72G, into which the positioning protrusions 64P are fit. The positioning recess 72G is a recess partially recessed from an inner peripheral part 73 of the cylindrical space 72S. The positioning recess 72G is also open outward on the base end side of the insulator 70. A width of the positioning recess 72G is equal to or larger than a width between the outward facing surfaces of the pair of positioning protrusions 64P. With the base end tube portion 64 accommodated on the base end side of the cylindrical space 72S, the positioning protrusions 64P are fit into the positioning recess 72G. In this way, the posture of the inner conductor 62 is kept constant with respect to the tube portion 72 about the center axis X of the tube portion 72. In this posture, ribs 74 to be described later are located between the plurality of resilient pieces 66 in a circumferential direction of the inner peripheral part 73 of the tube portion 72.

In the cylindrical space 72S, the plurality of resilient pieces 66 are accommodated on a side closer to the tip than a part where the base end tube portion 64 is arranged. The inner peripheral part 73 of the tube portion 72 is formed with the ribs 74. The rib 74 partially projects in a circumferential direction of the inner peripheral part 73 and extends along the direction of the center axis X of the tube portion 72.

The ribs 74 are located between the plurality of resilient pieces 66 in the circumferential direction of the inner peripheral part 73. Preferably, the ribs 74 are located at equal intervals about the center axis X of the tube portion 72 with respect to a center between the ribs 74 in the width direction. In this embodiment, since two gaps are present between the two resilient pieces 66 in the circumferential direction of the inner peripheral part 73, two ribs 74 are formed on the inner peripheral part 73. Preferably, the rib 74 is located in a center between the two resilient pieces 66 in the circumferential direction of the inner peripheral part 73 and intervals between the rib 74 and the resilient pieces 66 on both sides of the rib 74 are aligned. If the inner conductor includes three or more resilient pieces, three or more ribs may be formed. It is not essential that the ribs are provided in all of the plurality of gaps between the plurality of resilient pieces.

The ribs 64 are located in a region of the inner peripheral part 73 closer to the tip than a region where the base end tube portion 64 is located. That is, the ribs 74 project between the resilient pieces 66, but do not project from the inner peripheral part 73 in the region where the base end tube portion 64 is arranged. Thus, the base end tube portion 64 may not be formed with recesses corresponding to the ribs 74 and the base end tube portion 64 can be shaped as simple as possible.

A base end part of the rib 74 has a slope 74f gradually extending toward the center axis X of the tube portion 72 from the base end side toward the tip side of the tube portion 72. That is, the slope 74f is a surface for gradually reducing a projecting dimension of the base end part of the rib 74. Since the slope 74f is a surface inclined with respect to the center axis X of the tube portion 72, a tip part of the inner conductor 62 is hardly hooked to the base end parts of the ribs 74 when the inner conductor 62 is inserted into the tube portion 72, and the inner conductor 62 can be easily inserted into the tube portion 72. The base end tube portion 64 may be positioned by the base end parts of the ribs 74 contacting the base end tube portion 64 from the tip side.

In this embodiment, a surface of the rib 74 on the side of the center axis X is formed into an arcuately curved surface having the center axis X as a center of curvature. The surface of the rib 74 on the side of the center axis X may be a flat surface or a curved surface bulging toward the center axis X.

The inner peripheral part 73 of the tube portion 72 is formed with positioning ribs 76. The positioning rib 76 partially projects in the circumferential direction of the inner peripheral part 73 and extends along the direction of the center axis X of the tube portion 72. The positioning rib 76 is, for example, formed to have a semicircular or U-shaped transverse cross-section (cross-section in a direction orthogonal to a longitudinal direction). A projecting dimension of the positioning rib 76 from the inner peripheral part 73 is smaller than that of the rib 74 from the inner peripheral part 73.

In the inner peripheral part 73, the positioning ribs 76 are formed at positions avoiding the ribs 74. Further, in the inner peripheral part 73, the ribs 74 are formed at positions avoiding outer peripheral side positions of the resilient pieces 66. That is, in the circumferential direction of the inner peripheral part 73, the positioning ribs 76 are located between the resilient pieces 66 and the ribs 74 (see FIG. 9).

The positioning rib 76 is formed over the entire peripheral part 73 of the tube portion 72 in the longitudinal direction. With the base end tube portion 64 arranged in the base end part of the tube portion 72, tops of the positioning ribs 76 can contact an outer peripheral part of the base end tube portion 64. In this way, the base end tube portion 64 is positioned at a fixed position in the inner peripheral part 73. The tops of a plurality of (here, four) positioning ribs 76 contact the outer peripheral part of the base end tube portion 64 at equal intervals (here, at intervals of 90° about the center axis X), whereby the base end tube portion 64 is easily positioned to arrange the inner peripheral part 73 and the base end tube portion 64 on the same axis. The positioning ribs 76 may not extend toward between the resilient pieces 66.

Note that it is not essential that the inner peripheral part 73 is formed with the plurality of positioning protrusions 64P. It is not essential that the plurality of positioning protrusions 64P are formed at equal intervals about the center axis X.

The tip guide portion 80 is located on the tip side of the tube portion 72. The tip guide portion 80 includes an insertion hole 84 having a diameter smaller than an inner diameter of the inner peripheral part 73 of the tube portion 72. The center axis X of the tube portion 72 is aligned with a center axis X of the insertion hole 84.

The insertion hole 84 has a tapered guide surface 84 gradually reduced in diameter toward the inside of the tube portion 72. A maximum diameter on an outer side of the guide surface 84a is, for example, larger than a maximum opening width between the pair of guide pieces 66c and larger than the outer diameter of the base end tube portion 64. A minimum diameter on an inner side of the guide surface 84a is, for example, set to be smaller than the outer diameter of the base end tube portion 64 and nearly equal to the maximum opening width between the pair of guide pieces 66c (e.g. nearly equal within a range of ±2 mm). Thus, a tip part of the movable-side inner conductor 42 is guided toward between the plurality of resilient pieces 66 by the guide surface 84a.

Further, the insertion hole 84 has a constant-diameter guide surface 84b extending toward the tube portion 72 from a peripheral edge of the guide surface 84a on the side of the tube portion 72. A center axis X of the constant-diameter guide surface 84b is aligned with the center axis X of the tube portion. The constant-diameter guide surface 84b is so shaped that a minimum-diameter part on the inner side of the guide surface 84a is continuous along the center axis X.

Thus, the tip part of the movable-side inner conductor 42 is guided toward between the plurality of resilient pieces 66 while being restricted from shifting toward the outer peripheral side by the constant-diameter guide surface 84b after being guided toward the center axis X along the guide surface 84a.

By forming the constant-diameter guide surface 84b continuously with the guide surface 84a, an edge of the guide surface 84a on a minimum diameter side needs not be pointed. In this way, the guide surface 84 is hardly broken or deformed and a guide function is satisfactorily maintained by the guide surface 84a. Note that the constant-diameter guide surface 84b may be omitted.

In this embodiment, an outer peripheral part of the tip guide portion 80 projects further than the tube portion 72. An outer peripheral side guide surface 85 gradually expanded in diameter toward the tube portion 72 is formed on the outer peripheral part of the tip guide portion 80. The outer peripheral side guide surface 85 can function to guide a tubular part of the movable-side outer conductor 46 to an outer side of the outer conductor 90. It is not essential that the outer peripheral part of the tip guide portion 80 projects further than the tube portion 72.

The inner conductor 62 is assembled with the insulator 70 as follows. The base end tube portion 64 is inserted into the inner peripheral part 73 of the tube portion 72 through an opening on the base end side of the inner peripheral part 73. Then, the slopes of the locking protrusions 64b are pressed against the base end side opening and the inner peripheral part of the inner peripheral part 73. In this way, at least one of the base end tube portion 64 and the inner peripheral part 73 is deformed and the base end tube portion 64 is pushed into the inner peripheral part 73. At this time, the pair of positioning protrusions 64P are fit into the positioning recess 72G of the tube portion 72. The base end tube portion 64 is pushed into the inner peripheral part 73 until the pair of positioning protrusions 64P contact the back surface of the positioning recess 72G. In this state, the tops of the locking protrusions 64b bite into the inner peripheral part 73. Particularly, surfaces of the locking protrusions 64b facing the base end side of the base end tube portion 64 bite into and lock the inner peripheral part 73 to prevent the base end tube portion 64 from coming out. In this way, the base end tube portion 64 is held in the base end part of the inner peripheral part 73 of the tube portion 72. In this state, the respective resilient pieces 66 extend toward the tip side from the base end tube portion 64 and are arranged between the base end tube portion 64 and the tip guide portion 80 in the inner peripheral part 73.

The outer conductor 90 is made of an electrically conductive material such as metal and surrounds the insulator 70 made of metal or the like. The outer conductor 90 is, for example, formed by press-working a metal plate. In this embodiment, the outer conductor 90 includes an outer conductor tube portion 92 and outer conductor conductive pieces 94.

The outer conductor tube portion 92 is formed into such a tubular shape that the tube portion 72 can be arranged inside. The outer conductor tube portion 92 is formed with locking protrusions 92a partially projecting inward. The locking protrusions 92a bite into and lock the outer peripheral part of the tube portion 72 with the tube portion 72 arranged in the outer conductor tube portion 92, whereby the outer conductor tube portion 92 is supported at a fixed position with respect to the tube portion 72.

A plurality of the outer conductor conductive pieces 94 extend from an annular edge part on a tip side of the outer conductor tube portion 92. The plurality of outer conductor conductive pieces 94 are arranged to surround the outer peripheral part of the tube portion 72. The outer conductor conductive piece 94 is inclined toward an outer peripheral side toward the tip side and inclined toward an inner peripheral side at a halfway position thereof. A top 94a projecting most outward, out of the outer conductor conductive piece 94, is a contact point for contacting an inner peripheral part of a tube portion of the movable-side outer conductor 46. A part of the outer conductor conductive piece 94 closer to the tip side than the top 94a is a part for guiding the tube portion of the movable-side outer conductor 46 toward the top 94a.

As described above, the top 94a projects further toward the outer peripheral side than the tip side part and the base end side part. Thus, even if the outer conductor tube portion 92 is in an inclined posture with respect to the movable-side outer conductor 46, the tops 94a of the outer conductor conductive pieces 94 can contact and be conductive with the inner peripheral part of the tube portion of the movable-side outer conductor 46.

### <Connecting Operation of Relay Connector to Coaxial Connector>

A connecting operation in a cross-section passing through the center axis X and passing through the resilient pieces 66 is described. As described above, the relay connector 40 may be shifted in position with respect to the coaxial connector 60. Thus, a center axis of the relay connector 40 may be located at a different position or inclined with respect to the center axis X of the coaxial connector 60.

If the center axis of the movable-side inner conductor 42 of the relay connector 40 is located at a different position or inclined with respect to the center axis X of the coaxial connector 60 as shown in FIG. 8, the tip part of the movable-side inner conductor 42 contacts the guide surface 84a and is guided toward the center axis X of the coaxial connector 60 (see an arrow F1). In this way, the movable-side inner conductor 42 is guided toward between the plurality of resilient pieces 66. Particularly, since the resilient pieces 66 include the guide pieces 66c, the movable-side inner conductor 42 is more reliably guided toward between the contact point portions 66b. In this cross-section, the movable-side inner conductor 42 once guided toward between the resilient pieces 66 is kept in a state arranged between the plurality of resilient pieces 66 without coming out from between the plurality of resilient pieces 66.

A connecting operation in a cross-section passing through the center axis X and passing through between the resilient pieces 66 is described. As described above, the center axis of the relay connector 40 may be located at a different position or inclined with respect to the center axis X of the coaxial connector 60.

Even in this case, if the center axis of the movable-side inner conductor 42 of the relay connector 40 is located at a different position or inclined with respect to the center axis X of the coaxial connector 60 as shown in FIG. 7, the tip part of the movable-side inner conductor 42 contacts the guide surface 84a and is guided toward the center axis X of the coaxial connector 60. However, if the center axis of the movable-side inner conductor 42 of the relay connector 40 is inclined with respect to the center axis X of the coaxial connector 60, the tip part of the movable-side inner conductor 42 is thought to be pushed in to shift toward the inner peripheral wall of the tube portion 72 from between the plurality of resilient pieces 66.

Here, if the ribs 74 are omitted, a gap having a dimension W1 (see FIG. 7) is formed between the resilient piece 66 and the inner peripheral wall of the tube portion 72. If this dimension W1 is large, it is assumed that the movable-side inner conductor 42 enters this gap (see an arrow F2 of FIG. 7) and easily comes out from between the plurality of resilient pieces 66. Further, there is a possibility that the movable-side inner conductor 42 comes out from between the plurality of resilient pieces 66 and is stably accommodated between a side edge part of the resilient piece 66 and the inner peripheral wall side of the tube portion 72.

In contrast, if the inner peripheral part 73 is provided with the ribs 74, a dimension W2 (see FIG. 7) between the resilient piece 66 and the tip part of the rib 74 can be made smaller than the dimension W1. That is, the dimension W2 is smaller than the dimension W1 by the projecting dimension of the rib 74. Thus, the movable-side inner conductor 42 easily comes out from between the plurality of resilient pieces 66 as compared to the case where the ribs 74 are omitted. Further, a space in which the movable-side inner conductor 42 is stably accommodated is hardly formed between the resilient piece 66 and the inner peripheral part of the tube portion 72.

Thus, the movable-side inner conductor 42 is stably arranged between the plurality of resilient pieces 66 and the movable-side inner conductor 42 and the resilient pieces 66 are easily properly connected.

### <Effects, etc.>

According to the coaxial connector 60 configured as described above, the inner peripheral part 73 of the tube portion 72 is formed with the ribs 74 partially projecting in the circumferential direction of the inner peripheral part 73 and extending in an axial direction (here, coinciding with the center axis X) of the tube portion 72. Thus, the gap between the inner conductor 62 and the insulator 70 can be reduced in the part where the ribs 74 are formed. In this way, the movable-side inner conductor 42 as a mating conductor is hardly erroneously inserted between the inner conductor 62 and the insulator 70 and the movable-side inner conductor 42 can be satisfactorily connected to the inner conductor 62 accommodated in the insulator 70. In this way, a connection failure of the coaxial connector 60 and the relay connector 40 can be suppressed.

Particularly, since the ribs 74 are located between the plurality of resilient pieces 66 in the circumferential direction of the inner peripheral part 73, the ribs 74 hardly hinder the resilient deformation of the plurality of resilient pieces 66. That is, the ribs 74 are not formed on the outer peripheral sides of the resilient pieces 66 and larger gaps than in the part formed with the ribs 74 are present. Thus, if the movable-side inner conductor 42 is inserted between the plurality of resilient pieces 66, the resilient pieces 66 can be smoothly resiliently deformed toward the outer peripheral sides. In this way, the movable-side inner conductor 42 can be smoothly inserted between the plurality of resilient pieces 66. Further, the ribs 74 can be suppressed from erroneously entering between the inner conductor 62 and the insulator 70 between the plurality of resilient pieces 66 and the inner peripheral part 73.

Further, the plurality of resilient pieces 66 are located at equal intervals about the center axis X, and the ribs 74 are also located at equal intervals about the center axis X. Thus, the plurality of resilient pieces 66 can uniformly sandwich the movable-side inner conductor 42 from around and the movable-side inner conductor 42 and the inner conductor 62 can be satisfactorily electrically connected. Further, the plurality of ribs 74 can uniformly suppress the erroneous insertion of the movable-side inner conductor 42 between the plurality of resilient pieces 66.

Further, since the ribs 74 are located in a region closer to the tip side than the base end tube portion 64 in the tube portion 72, the base end tube portion 64 may not be shaped to avoid the ribs 74. In this way, the base end tube portion 64 is easily processed.

Further, since the base end part of the rib 74 has the slope 74f extending toward the center axis X toward the tip side, the resilient pieces 66 are hardly hooked to the base end part of the rib 74 when the inner conductor 62 is inserted into the insulator 70, and the inner conductor 62 is smoothly inserted into the tube portion 72.

Further, the base end tube portion 64 includes the positioning protrusions 64P and the tube portion 72 includes the positioning recess 72G, into which the positioning protrusions 64P are fit. Thus, the ribs 74 can be precisely located between the plurality of resilient pieces 66 in the circumferential direction of the inner peripheral part 73 of the tube portion 72 by fitting the positioning protrusions 64P into the positioning recess 72G.

Further, the positioning ribs 76 are formed on the inner peripheral part of the tube portion 72. By the contact of these positioning ribs 76 with the outer peripheral part of the base end tube portion 64, the base end tube portion 64 is easily supported at the fixed position in the tube portion 72. If the entire inner peripheral part of the tube portion is configured to be in contact with the entire outer periphery of the base end tube portion without any gap and position the tube portion, it is difficult to insert the base end tube portion into the tube portion if the base end tube portion is slightly shifted in position or inclined with respect to the tube portion. If the positioning ribs 76, which are partial projecting parts, are configured to position the base end tube portion 64, the tube portion 72 can receive the base end tube portion 64 by utilizing the gaps between the positioning ribs 76 in the circumferential direction and/or deforming the positioning ribs 76 even if the base end tube portion 64 is slightly shifted in position or inclined with respect to the tube portion 72.

Further, if the plurality of positioning ribs 76 are located at equal intervals about the center axis X, the center axis of the tube portion 72 and that of the base end tube portion 64 are easily aligned. Further, since the plurality of positioning ribs 76 can be deformed, the base end tube portion 64 is easily inserted.

Further, the insulator 70 includes the tip guide portion 80 located on the tip side of the tube portion 72 and having the insertion hole 84 with the diameter smaller than the inner diameter of the tube portion 72. This insertion hole 84 has the guide surface 84a gradually reduced in diameter toward the inside of the tube portion 72. Thus, the movable-side inner conductor 42 is guided toward the inner conductor 62 by the guide surface 84a. In this way, the movable-side inner conductor 42 is hardly erroneously inserted between the inner conductor 62 and the insulator 70, and the movable-side inner conductor 42 can be more satisfactorily connected to the inner conductor 62 accommodated in the insulator 70.

Further, the insertion hole 84 has the constant-diameter guide surface 84b extending toward the tube portion 72 from the peripheral edge of the guide surface 84a on the side of the tube portion 72. Thus, the constant-diameter guide surface 84b can more reliably guide the movable-side inner conductor 42 toward the inner conductor 62. Further, the peripheral edge of the guide surface 84a on the side of the tube portion 72 is hardly deformed or broken.

Further, the outer conductor 90 includes the outer conductor conductive pieces 94 conductive with the movable-side outer conductor 46 in a posture oblique to the movable-side outer conductor 46. In this way, position errors of the coaxial connector 60 and the relay connector 40 can be absorbed. In this case, the inner conductor 62 and the movable-side inner conductor 42 are thought to be in oblique postures. Even in this case, the movable-side inner conductor 42 is hardly erroneously inserted between the inner conductor 62 and the insulator 70, and the movable-side inner conductor 42 can be satisfactorily connected to the inner conductor 62 accommodated in the insulator 70.

### Modifications

The configuration relating to the ribs 74 of the coaxial connector 60 may be applied to the relay connector 40 or the external connection coaxial connector 30. Further, the coaxial connector 60 may be applied to the connection of coaxial connectors not based on the device 10.

Also when the resilient pieces of the inner conductor are not located at intervals in the circumferential direction, the mating conductor is hardly erroneously inserted between the inner conductor and the insulator in the part provided with the ribs 74. Thus, it is not essential that the inner conductor includes the plurality of resilient pieces located at intervals in the circumferential direction.

Note that the respective configurations described in the above embodiment and the respective modifications can be appropriately combined as long as these do not contradict each other.

### LIST OF REFERENCE NUMERALS

10 device
12 case
13 first case
14 second case
15 bottom part
16 holding tube portion
17 holding/partitioning portion
17h holding hole
18a locking protrusion
20 electrical component
21 circuit board
22 imaging element
30 external connection coaxial connector
32 external connection inner conductor
34 external connection insulator
36 external connection outer conductor
40 relay connector (mating coaxial connector)
42 movable-side inner conductor (mating inner conductor)
44 movable-side insulator
46 movable-side outer conductor (mating outer conductor)
60 coaxial connector
62 inner conductor
64 base end tube portion
64P positioning protrusion
64S slit
64a extended piece
64b locking protrusion
66 resilient piece
66a intermediate piece
66b contact point portion
66c guide piece
70 insulator
72 tube portion
72G positioning recess
72S cylindrical space
73 inner peripheral part
74 rib
74f slope
76 positioning rib
80 tip guide portion
84 insertion hole
84a guide surface
84b constant-diameter guide surface
85 outer peripheral side guide surface
90 outer conductor
92 outer conductor tube portion
92a locking protrusion
94 outer conductor conductive piece
94a top
X center axis

1. A coaxial connector to be connected to a mating coaxial connector including a mating inner conductor, comprising:
an inner conductor to be connected to the mating inner conductor;
an insulator including a tube portion for accommodating the inner conductor; and
an outer conductor surrounding the insulator,
an inner peripheral part of the tube portion being formed with a rib partially projecting in a circumferential direction of the inner peripheral part of the tube portion and extending along an axial direction of the tube portion.

2. The coaxial connector of claim 1, wherein:
the inner conductor includes a plurality of resilient pieces located at intervals in the circumferential direction, and
the rib is located between the plurality of resilient pieces in the circumferential direction.

3. The coaxial connector of claim 2, wherein:
the plurality of resilient pieces are located at equal intervals about a center axis of the tube portion,
a plurality of the ribs are provided, and
the plurality of ribs are located at equal intervals about the center axis of the tube portion.

4. The coaxial connector of claim 2, wherein:
the inner conductor includes a base end tube portion located on a base end side of the tube portion and the plurality of resilient pieces extend from the base end tube portion toward a tip side of the tube portion, and
the rib is located in a region closer to the tip side of the tube portion than the base end tube portion.

5. The coaxial connector of claim 4, wherein a base end part of the rib has a slope gradually extending toward the center axis of the tube portion from the base end side toward the tip side of the tube portion.

6. The coaxial connector of claim 4, wherein:
the base end tube portion includes a positioning protrusion partially projecting toward an outer peripheral side in a circumferential direction of the base end tube portion, and
the tube portion includes a positioning recess, the positioning protrusion being fit into the positioning recess.

7. The coaxial connector of claim 4, wherein the inner peripheral part of the tube portion is formed with a positioning rib partially projecting in the circumferential direction, extending along the center axis of the tube portion and in contact with an outer peripheral part of the base end tube portion.

8. The coaxial connector of claim 7, wherein:
a plurality of the positioning ribs are provided, and
the plurality of positioning ribs are located at equal intervals about the center axis of the tube portion.

9. The coaxial connector of claim 1, wherein:
the insulator includes a tip guide portion located on a tip side of the tube portion and having an insertion hole with a diameter smaller than an inner diameter of the tube portion, and
the insertion hole has a guide surface gradually reduced in diameter toward inside of the tube portion.

10. The coaxial connector of claim 9, wherein the insertion hole has a constant-diameter guide surface extending toward the tube portion from a peripheral edge of the guide surface on the tube portion side.

11. The coaxial connector of claim 1, wherein the outer conductor includes an outer conductor conductive piece conductive with a mating outer conductor in a posture oblique to the mating outer conductor of the mating coaxial connector.
